(19) United States
(12) Patent Application Publication
(10) Pub. No.: US 2008/0204831 A1
(43) Pub. Date: Aug. 28, 2008

(54) Image producing apparatus, image producing method, and image producing program

(75) Inventor: Loi Yew Kien, Singapore (SG)

Correspondence Address: Edwards Angell Palmer & Dodge LLP, P.O. Box 55874, Boston, MA, 02205, US

(73) Assignee: Seiko Epson Corporation, Tokyo (JP)

(21) Appl. No.: 12/012,117

(22) Filed: Jan. 31, 2008

(30) Foreign Application Priority Data
Feb. 1, 2007 (JP) 2007-023560

(51) Int. Cl. H04N 1/04; H04N 1/46

(52) U.S. Cl. 358/509; 358/474; 358/475; 250/206

(57) ABSTRACT

An image producing apparatus includes a light-emitting element, a light-receiving section, a control section which controls the light-emitting element to emit a light by outputting a light-emitting control value to the light-emitting element, a recording section which records an ideal output value for every light-emitting control value, an output value acquiring section which acquires a reference output value outputted from the light-receiving section which has received the light from the reference region for every light-emitting control value, and an output section which outputs a difference output value between the reference output value and the ideal output value for every reference output value by comparing the reference output value matched with the same light-emitting control value.

### BACKGROUND

1. Technical Field

The present invention relates to an image producing apparatus, an image producing method, and an image producing program, and more particular to an image producing apparatus, an image producing method, and an image producing program, which output a difference output value which is a difference between a reference region output value and an ideal output value.

2. Related Art

JP-A-2000-278498 discloses an image reader that suppresses deterioration of an output image, attributable to defective light-receiving elements. The image reader corrects defective pixels by imaging a white reference provided in an apparatus before reading.

However, the image reader performs uniform image correction with respect to entire data by a fixed width on the basis of a read value of white reference, and thus the image reader has a disadvantage in that a nonlinear reading error which is different according to mean value of a shade in reading elements cannot be properly corrected.

### SUMMARY

According to a first aspect of the invention, there is provided an image producing apparatus which includes a light-emitting element irradiating a manuscript with irradiating light and a light-receiving section receiving reflected light or transmitted light from the irradiated manuscript and which produces an image of the manuscript on the basis of an output value outputted from the light-receiving section, the image producing apparatus including a control section causing the light-emitting element to emit the irradiating light by outputting a light-emitting control value corresponding to intensity of the irradiating light to the light-emitting element, an ideal output value storage section for storing an ideal output value which should be outputted from the light-receiving section which has received reflected light or transmitted light from a reference region for every light-emitting control value when the reference region used for measuring a reference output value of an output value is irradiated with the irradiating light having a plurality of different intensities in response to a plurality of different light-emitting control values outputted from the light-emitting control section, an output value acquiring section for acquiring the reference output value actually outputted from the light-receiving section which has received the reflected light or the transmitted light from the reference region for every light-emitting control value when the reference region is irradiated with the irradiating light having the plurality of different intensities by the light-emitting element in response to the plurality of different light-emitting control values, and a difference output value output section for outputting a difference output value between the reference output value and the ideal output value for every reference output value by comparing the reference output value matched with the same light-emitting control value and acquired by the output value acquiring section and the ideal output value recorded in the recording section, when the reference region output value is acquired by the output value acquiring section for every light-emitting control value. Thanks to this structure, it is possible to properly correct a nonlinear reading error according to the mean value of shades in the light-receiving section.

In the image producing apparatus, it is preferable that the light-emitting control section causes the light-emitting element to irradiate the reference region with the irradiating light having a plurality of different intensities by outputting a plurality of different light-emitting control values to the light-emitting element before image production when it receives a request for producing an image of the manuscript. Thanks to this structure, it is possible to create a difference output value for every reference region output value and thus it is possible to read and correct the image of the manuscript with high precision.

In the image producing apparatus, it is preferable that the light-emitting control section outputs the light-emitting control values having a smaller pitch as the intensity of the irradiating light emitted by the light-emitting element is weaker, and the ideal output value storage section stores the ideal output value for every light-emitting control value outputted from the light-emitting control section. Thanks to this structure, it is possible to read and correct the image of manuscript with high precision with respect to a portion having lower brightness where an error is likely to occur in the output values outputted from the light-receiving section.

In the image producing apparatus, it is preferable that the light-emitting control section sequentially outputs the plurality of different light-emitting control values in the sequence that the light-emitting control values decrease the intensity of the irradiating light emitted from the light-emitting element in a fixed ratio, and the recording section records the ideal output value for every light-emitting control value outputted from the light-emitting control section. Thanks to this structure, it is possible to weaken the intensity of the irradiating light by degrees by simple internal processing.

In the image producing apparatus, it is preferable that the light-emitting control section outputs the light-emitting control values having a smaller pitch in a region in which the intensity of the irradiating light emitted from the light-emitting section 102 is relatively weak rather than a range in which the intensity of the irradiating light emitted from the light-emitting section 102 is relatively strong, and the ideal output value storage section stores the ideal output values for every light-emitting control value having a smaller pitch in the range in which the intensity of the irradiating light emitted from the light-emitting section is relatively weak rather than the range in which the intensity of the irradiating light emitted from the light-emitting section is relatively strong.

In the image producing apparatus, it is preferable that the light-emitting element is an LED which illuminates with a plurality of different duties and the light-emitting control section causes the LED to emit the irradiating light having a plurality of different intensities by outputting the light-emitting control values which cause the LED to illuminate with the plurality of different duties.

In the image producing apparatus, it is preferable that the output value acquiring section computes a linear function using the light-emitting control value and the output value as variables, in which the light-emitting control value and the output value includes the reference output value acquired when a maximum light-emitting control value is outputted from the control section, the maximum light-emitting control value, the reference output value acquired when the reference region is not irradiated with the irradiating light by the light-emitting element, and the light-emitting control value showing that the reference region is not irradiated with the irradiating light, and the ideal output value storage section stores a set of the light-emitting control value and the ideal output value which satisfy the linear function when the linear function is computed by the output value acquiring section. Thanks to this structure, it is possible to easily and dynamically acquire the ideal output value and the difference output value.

In the image producing apparatus, it is preferable that the light-emitting control section generates different light-emitting control values according to a plurality of different image producing modes for producing an image of the manuscript, the ideal output value storage section stores different ideal output values for every light-emitting control value according to the plurality of different image producing modes for producing the image of the manuscript, and the output value acquiring section acquires the different reference output values for every light-emitting control value according to the plurality of different image producing modes for producing the image of the manuscript. Thanks to this structure, different difference output values are acquired according to image producing modes. Accordingly, it is possible to perform proper correction of the image according to the image producing mode. In addition, for example, the image producing modes are set according to the resolution of the image and may include a photograph mode.

In the image producing apparatus, it is preferable that the image producing apparatus further includes an output value correction section which corrects an actual measurement value which is an output value of the light-receiving section which has received the reflected light or the transmitted light from the manuscript on the basis of the difference output value outputted from the difference output value output section and outputs a correction value. According to this structure, it is possible to correct the image of the manuscript in the image producing apparatus.

According to a second aspect of the invention, there is provided an image producing method which produces an image of a manuscript on the basis of an output value outputted from a light-receiving section in an image producing apparatus including a light-emitting element which irradiates the manuscript with irradiating light and the light-receiving section which has a light-receiving element which receives reflected light or transmitted light from the irradiated manuscript. The image producing method includes a light-emitting control step of causing the light-emitting element to emit the irradiating light by outputting a light-emitting control value corresponding to intensity of the irradiating light emitted from the light-emitting element to the light-emitting element, an ideal output value storage step of storing ideal output values which should be outputted from the light-receiving section which has received reflected light or transmitted light from a reference region for every light-emitting control value when the reference region used for measuring a reference value of an output value is irradiated with the irradiating light having a plurality of different intensities by the light-emitting element in response to a plurality of different light-emitting control values outputted from the light-emitting element, an output value acquiring step of acquiring a reference region output value which is an output value actually outputted from the light-receiving section which has received the reflected light or the transmitted light from the reference region for every light-emitting control value outputted in the light-emitting control step when the reference region is irradiated with the irradiating light having the plurality of intensities by the light-emitting element in response to the plurality of light-emitting control values outputted in the light-emitting control step, and a difference output value output step of outputting a difference output value which is a difference between the reference output value and the ideal output vale for every reference output value by comparing the reference output value matched with the same light-emitting control value and acquired in the output value acquiring step and the ideal output value which is stored in the output value storage step. According to this aspect, it is possible to obtain the same advantage of the first aspect.

According to a third aspect of the invention, there is provided a program for controlling an image producing apparatus which produces an image of a manuscript on the basis of an output value outputted from a light-receiving section in an image producing apparatus including a light-emitting element which irradiates the manuscript with irradiating light and the light-receiving section which has a light-receiving element receiving reflected light or transmitted light from the manuscript which is irradiated with the irradiating light. The program executes the following steps in the image producing apparatus. The steps include a light-emitting control step of causing the light-emitting element to emit the irradiating light by outputting a light-emitting control value corresponding to intensity of the irradiating light emitted from the light-emitting element to the light-emitting element, an ideal output value storage step of storing an ideal output value which should be outputted from the light-receiving section which has received reflected light or transmitted light from a reference region for every light-emitting control value when the reference region used for measuring a reference value of an output value is irradiated with the irradiating light having a plurality of different intensities by the light-emitting element in response to a plurality of different light-emitting control values outputted from the light-emitting element, an output value acquiring step of acquiring a reference region output value which is an output value actually outputted from the light-receiving section which has received the reflected light or the transmitted light from the reference region for every light-emitting control value outputted in the light-emitting control step when the reference region is irradiated with the irradiating light having the plurality of intensities by the light-emitting element in response to the plurality of light-emitting control values outputted in the light-emitting control step, and a difference output value output step of outputting a difference output value which is a difference between the reference output value and the ideal output value for every reference output value by comparing the reference output value matched with the same light-emitting control value and acquired in the output value acquiring step and the ideal output value which is stored in the output value storage step. According to this aspect, it is possible to obtain the same advantage of the first aspect.

In addition, the outline of the above-mentioned invention is not necessarily what all the features of this invention are enumerated but sub-combinations of these features can also be the invention.

### BRIEF DESCRIPTION OF THE DRAWINGS

The invention will be described with reference to the accompanying drawings, wherein like numbers reference like elements.

FIG. 1 is a view illustrating an exemplary scanner 20.

FIG. 2 is a block diagram illustrating the scanner 20.

FIG. 3 is a flow chart illustrating sequence of operations of the scanner 20.

FIG. 4 is a view illustrating an example of information stored in an ideal output vale storage section 120.

FIG. 5 is a view illustrating an example of an output value before correction and an output value after correction.

### DESCRIPTION OF EXEMPLARY EMBODIMENTS

Although this invention is explained in the form of embodiment, the following embodiments do not limit the invention concerning claims and not all the combination of features in the following embodiment necessarily indispensable for the solution of invention.

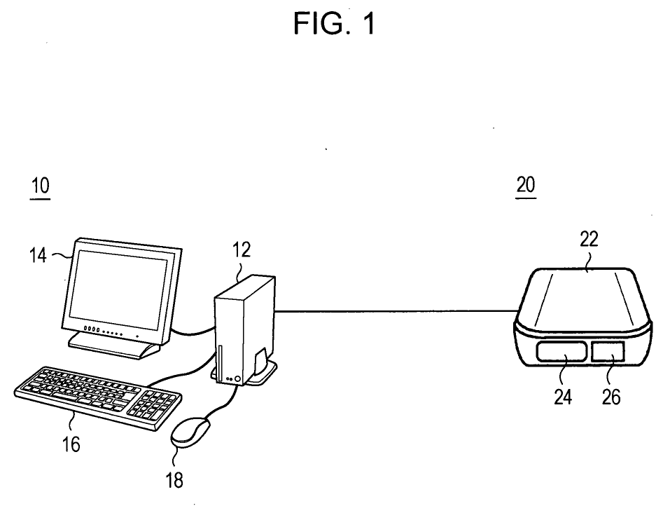

FIG. 1 shows an exemplary scanner 20. The scanner 20 is an example of an image producing apparatus and includes a main body 22, a display 24 for performing display on the basis of the output from the main body 22 to a user, and a manipulation panel 26 serving as an input unit for inputting information into the main body 22. The scanner 20 is connected with a personal computer 10 via a network. The personal computer 10 includes a main body 12, a display 14 for performing display on the basis of the output from the main body 12 to a user, and an input unit such as a keyboard 16 and a mouse 18 for allowing the user to input information into the main body 12.

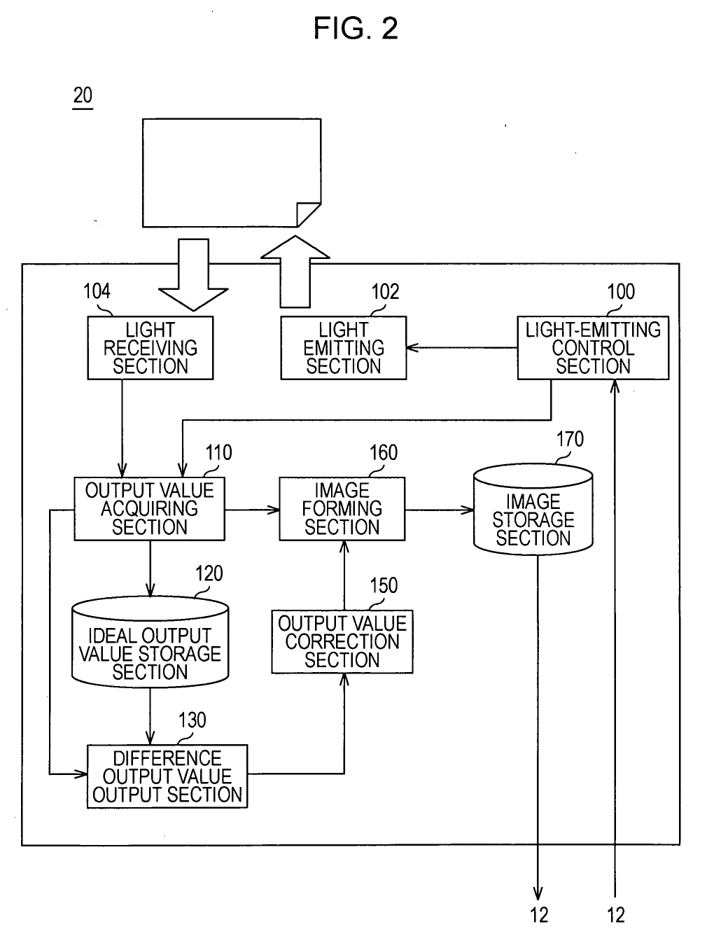

FIG. 2 is a block diagram showing the scanner 20. The scanner 20 includes a light-emitting control section 100, a light-emitting section 102, a light-receiving section 104, an output value acquiring section 110, an ideal output value storage section 120, a difference output value output section 130, an output value correction section 150, an image forming section 160, and an image storage section 170. The light-receiving section 104 outputs a predetermined output value in response to reflected light or transmitted light which is detected by a photoelectric effect.

The light-emitting section 102 includes a plurality of light-emitting elements which irradiate a manuscript with irradiating light in response to control values from the light-emitting control section 100. Moreover, the light-receiving section 104 includes a plurality of light-receiving elements which receives the reflected light or transmitted light from the manuscript irradiated with the irradiating light, and an analog-to-digital (AD) converter which converts analog values, such as voltages from the light-receiving elements, to digital values such as pixel values. Examples of the light-receiving elements include a photo-diode, a CCD, a CMOS, etc. In this case, the light-receiving section 104 outputs a pixel value of 16 bits. Moreover, the light-receiving section 104 may output the pixel values after carrying out shading compensation with respect to the pixel values from the AD converter.

The light-emitting control section 100 outputs light-emitting control values corresponding the intensities of the irradiating light emitted from the light-emitting section 102 and send them to the light-emitting section 102. The light-emitting control section 100 may cause the light-emitting section 102 to irradiate a reference region used for measuring a reference output value of output values of the light-receiving section 104 with the irradiating light having a plurality of different intensities by outputting and sending a plurality of different light-emitting control values to the light-emitting section 102 before image production when it receives a request for producing an image of the manuscript from outside. Thereby, it is possible to generate difference values for every reference region output value before image production and thus it is possible to read the manuscript with high precision and correct an image of the manuscript. In this case, the light-emitting control section 100 controls a plurality of light-emitting elements provided to the light-emitting section 102 to emit the irradiating light having a uniform intensity. In addition, the reference region such as white region has high reflectivity and is disposed outside a manuscript base, for example, at a region between the manuscript base and a home position of the light-emitting section 102. The reference region can be obviously understood by people ordinarily skilled in the art from the publication of, for example, JP-A-2000-278498. Accordingly, detailed explanation thereof will be omitted.

Moreover, an example of the light emitting element provided to the light-emitting section 102 is a light-emitting diode (LED). In this case, the light-emitting control section 100 causes the LEDs to emit the irradiating light having the plurality of different intensities by outputting the light-emitting control values, which make the LEDs illuminate with the plurality of different duties, to the light-emitting section 102. For example, the light-emitting control section 100 generates the light-emitting control values in synchronization with a clock signal with which the light-receiving section 104 scans a single line. Thus, the light-emitting control section 100 causes the LED to illuminate with a higher duty by the light-emitting control value which sets a time to supply driving current to the LED relatively longer, but conversely the light-emitting control section 100 causes the LED can to illuminate by a lower duty by the light-emitting control value which sets a time to supply the driving current relatively shorter. Here, light-emitting period of the LEDs overlaps with image reading period of the light-receiving section 104, and the change of the duty is applied to the intensity of light received by the light-receiving section 104. Moreover, as another example, the light-emitting control section 100 generates the light-emitting control values each being a repetition frequency higher than that of clock signals. The LEDs may be made to emit light with a higher duty by the light-emitting control value of a higher repetition frequency during an interval between the clock signals. Conversely, the LED may be made to emit light with a lower duty by the light-emitting control value of a lower repetition frequency.

Moreover, the light-emitting control section 100 outputs a plurality of light-emitting control values having a smaller pitch therebetween as the intensity of the irradiating light from the light-emitting section 102 is decreased. For example, when using the duty as the light-emitting control value, the light-emitting control section 100 outputs the light-emitting control values of duties which are different from each other by a small amount when the intensity of the irradiating light emitted from the light-emitting section 102 is weak. In this case, the light-emitting control section 100 may store that with which duty the light-emitting section 102 illuminates. By this operation, in the portion with lower brightness where an error is likely to occur in the output vales outputted from the light-receiving elements, it is possible to read the manuscript with higher precision and correct the image which is read out. In addition, the light-emitting control section 100 causes the light-emitting section 102 to illuminate with the duty set up on the basis of reading condition, when reading the manuscript arranged on the manuscript base. In addition, the details of the change of the duty are described later.

When the reference region is irradiated with the irradiating light having the plurality of different intensities which change by the plurality of different light-emitting control values outputted from the light-emitting control section 100 by the light-emitting section 102, the output value storage section 120 stores “the ideal output values that should be outputted from the light-receiving section 104 which has received the light transmitted through or reflected from the reference region” (hereinafter, referred to as “ideal output values” for every light-emitting control value. In this case, the ideal output value storage section 120 stores the ideal output values for every light-emitting control value having a smaller pitch in a range in which the intensity of the irradiating light emitted from the light-emitting section 102 is relatively weak rather than a range in which the intensity of the irradiating light emitted from the light-emitting section 102 is relatively strong in response to the light-emitting control values outputted from the light-emitting control section 100.

When the reference region is irradiated with the irradiating light having a predetermined intensity by the light-emitting section 102 in response to a predetermined light-emitting control value outputted from the light-emitting control section 100, the output value acquiring section 110 acquires “an output value which is actually outputted from the light-receiving section 104 which has received the light reflected from or transmitted through the reference region” (hereinafter, referred to as “reference region output value”). Furthermore, the output value acquiring section 110 matches the acquired output value with the light-emitting control value outputted from the light-emitting control section 100, and stores the reference region output value in the ideal output value storage section 120. In this case, the output value acquiring section 110 acquires the reference region output values for every light-emitting control value outputted from the light-emitting control section 100, and stores them in the ideal output value storage section 120.

The difference output value output section 130 matches the reference region output value with the light-emitting control value when the reference region output value is acquired by the output value acquiring section 110, and then compares this with the ideal output value stored in the ideal output value storage section 120, thereby finally outputting “an output value which is a difference between the reference region output value and the ideal output value” (hereinafter, referred to as “difference output value”). In this case, the difference output value output section 130 acquires the reference region output values for every light-emitting control value by the output value acquiring section 110, compares the corresponding reference region output values with the ideal output values matched with the same light-emitting control values and stored in the ideal output value storage section 120, and outputs the difference output values for every reference region output value.

The output value correction section 150 corrects an actual measurement value which is an output value outputted from the light-receiving section 104 which has received the light reflected from or transmitted through the manuscript on the basis of the difference output value outputted form the difference output value output section 130 and outputs a correction value. In this case, the output value correction section 150 may output the correction value which is acquired by adding the difference output value to the actual measurement value. Moreover, the output value correction section 150 may first read the difference output value stored in the ideal output value storage section 120, and may correct the output value on the basis of the read value. Moreover, in the case, the image forming section 160 may have a function of gamma correction, and the image forming section 160 may output the pixel value acquired by performing both the above-mentioned correction processing and the gamma correction processing.

The image forming section 160 forms an image of the manuscript on the basis of the actual measurement value outputted from the light-receiving section 104 which has received the light reflected from or transmitted through the manuscript and the correction value outputted from the output value correction section 150. The image storage section 170 stores the image of the manuscript formed by the image forming section 160. In this manner, it is possible to correct the image of the manuscript in image producing apparatus.

The output value acquiring section 110 may compute a linear function having variables of the light-emitting control value and the output value including the reference region output value acquired when a maximum light-emitting control value is outputted, the maximum light-emitting control value, the reference region output value acquired when the reference region is irradiated with no irradiating light by the light-emitting section 102, and the light-emitting control value representing no irradiating light is emitted. When the linear function is computed by the output value acquiring section 110, the ideal output value storage section 120 may store a set of the light-emitting control value and the ideal output value which satisfy the linear function. Thanks to this structure, it is possible to simply and dynamically acquire the ideal output value and the difference output value.

Moreover, the light-emitting control section 100 may output the different light-emitting control values depending on a plurality of different image producing modes for producing the image of the manuscript. In this case, the ideal output value storage section 120 stores different ideal output values for every light-emitting control value depending on the plurality of different producing modes for producing the image of the manuscript, and may acquire different reference region output values for every light-emitting control value depending on the plurality of different producing modes for producing the image of manuscript. In this manner, the difference output values are acquired according to the image producing modes. Accordingly, it is possible to properly correct the image according to the image producing modes. For example, the plurality of different image producing modes includes a reflective reading mode in which the image of the manuscript is acquired by irradiating an opaque medium such as paper with light and then detecting the light reflected from the opaque medium and a transmissive reading mode in which the image of the manuscript is acquired by irradiating a transparent or translucent medium such as silver salt film with light and detecting the light transmitted through the medium. In these examples, the light-emitting control section 100 may set a pitch of the plurality of light-emitting control values smaller in the transmissive reading mode than that in the reflective reading mode in a range in which the intensity of the irradiating light emitted by the light-emitting section 102 is relatively weaker.

The scanner 20 includes a program which is stored in a read only memory (Rom) and which executes operations of the light-emitting control section 100, the light-emitting section 102, the light-receiving section 104, the output value acquiring section 110, the ideal value storage section 120, the difference output value output section 130, the output value correction section 150, the image forming section 160, and the image storage section 170.

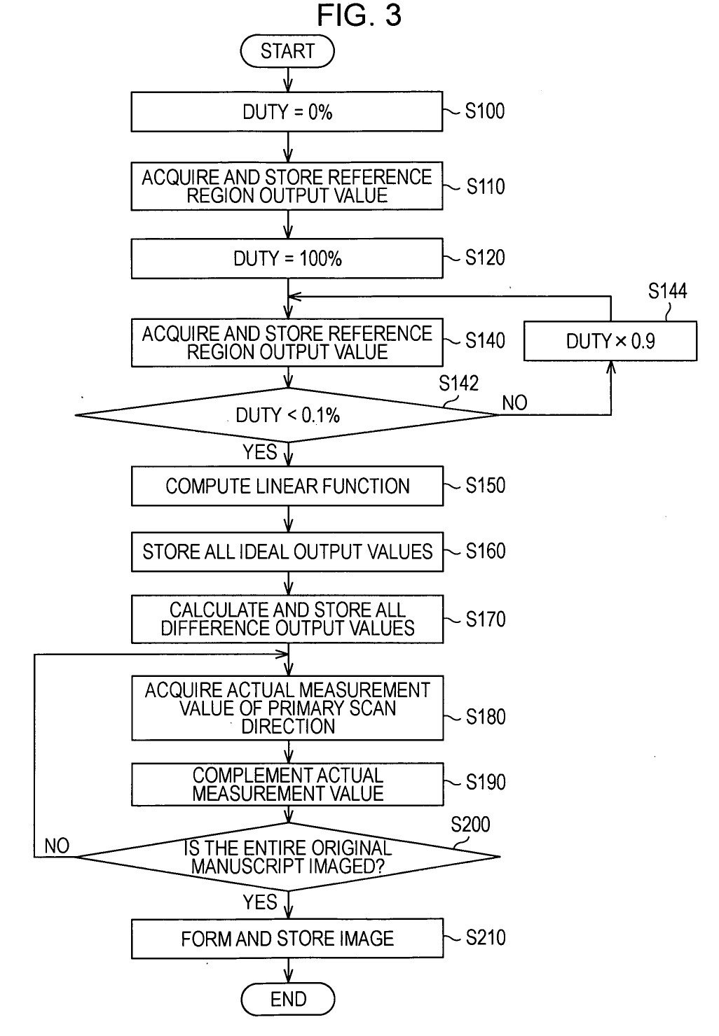

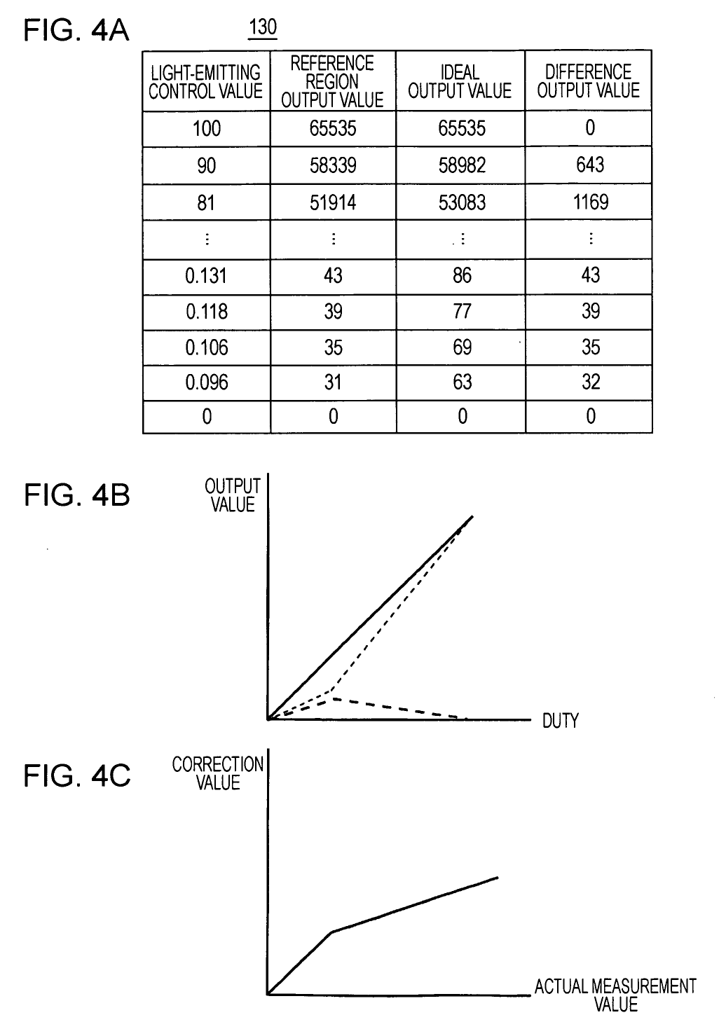

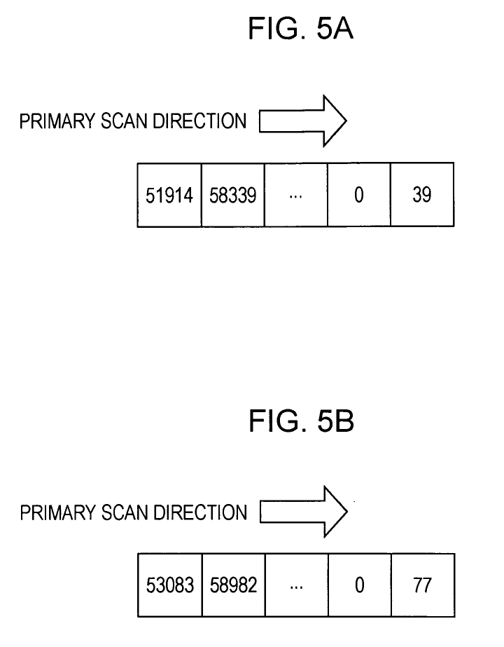

FIG. 3 is a flow chart illustrating an exemplary operation of the scanner 20. FIG. 4 shows an example of information stored in the ideal output value storage section 120. FIG. 5 shows an example of actual measurement values and correction values. According to the flowchart shown in FIG. 3, the operation is started with a read step of receiving an input of the purport for reading a manuscript mounted on a manuscript base via the manipulation panel 26. In addition, the light-receiving section 104 includes a plurality of light-receiving elements which are lined up. The light-receiving section 104 performs alternately an imaging operation of reading the light reflected from the manuscript in a “row direction of the light-receiving elements” (hereinafter, referred to as “primary scan direction”) and a moving operation of moving in a “direction intersecting the primary scan direction” (hereinafter, referred to as “auxiliary scan direction”). In every imaging operation, the light-receiving section 104 outputs output values of the respective light-receiving elements which are lined up and sends the output vales to the output value acquiring section 110. In addition, although the operation relates to the case in which the light-receiving elements receive the light which is emitted from the light-emitting elements and then reflected from the manuscript, the operation of the light-receiving section 104 is not limited thereto. That is, the light-receiving section 104 may receive the light which is emitted from the light-emitting elements and then transmitted through the manuscript.

The light-emitting control section 100 notifies the output value acquiring section 110 that it is necessary to acquire a reference region output value which is measured from the reference region under the condition in which no irradiating light from the light-emitting section 102 is incident on the reference region, in other words, under the case in which the duty of the LED is 0% (S100). The output value acquiring section 110 which has received the notice acquires the reference region output value outputted when the reference region is irradiated with no irradiating light by the light-emitting section 102 from the light-receiving section 104 (S110). In this case, the output value acquiring section 110 obtains the arithmetic average of the output values of a plurality of light-receiving elements, and takes it as a reference region output value. In addition, before Step S110, the light-receiving section 104 performs the shading compensation and may output the pixel value after the shading compensation. Furthermore, the output value acquiring section 110 matches the light-emitting control value “0” which means no irradiating light is incident on an object with the reference region output value and stores such reference region output value in the ideal output value storage section 120 (the same step). In an example shown in FIG. 4A, the output value acquiring section 110 stores the reference region output value matched with the light-emitting control value “0” in the ideal output value storage section 120.

Next, the light-emitting control section 100 notifies the output value acquiring section 110 that it is necessary to acquire a reference region output value relating to the case in which the duty of LED is 100%, i.e., the case in which the reference region is irradiated with the irradiating light having the maximum intensity by the light-emitting section 102 (S120). The output value acquiring section 110 acquires the reference region output value relating to the case in which the reference region is irradiated with the irradiating light having the maximum intensity from the light-receiving section 104 (S140). In this case, the output value acquiring section 110 takes the arithmetic average of the output values from the plurality of light-receiving elements and takes it as the reference region output value. Furthermore, the output value acquiring section 110 matches the light-emitting control value “100” which means that the irradiating light with the maximum intensity is irradiated with the reference region output value, and stores such reference region output value in the ideal output value storing section 120 (the same step). In the example shown in FIG. 4A, the output value acquiring section 110 stores the reference region output value “65535” matched with the light-emitting control value “100” in the ideal output value storing section 120.

Furthermore, the light-emitting control section 100 judges whether the light-emitting control value became smaller than a predetermined minimum value, i.e. whether the duty of LED became less than 0.1% in this example (S142). In this step S142, the light-emitting control section 100 weakens the light-emitting control values in a fixed ratio (S144) when it is judged that the light-emitting control value is not smaller than the predetermined minimum value (S142: No). In this example, the light-emitting control section 100 outputs the light-emitting control value which decreases the duty of the LED to 90 percent of the last duty, and performs Step S140. Next, in Step S142, Steps S140, S142, and S144 are repeated until the light-emitting control section 100 judges that the light-emitting control value outputted to the light-emitting section 102 for the last time is a light-emitting control value which causes the LED emit to illuminate with less than 0.1% of duty (S142: Yes).

In Step S142, when the duty of the LED which is outputted to the light-emitting section 102 for the last time by the light-emitting control section 100 is judged to be less than 0.1% (S142: Yes), the output value acquiring section 110 computes the ideal output value (S150). In this case, the output value acquiring section 110 computes a linear function in which a light-emitting control value and an output value are variables on the basis of the reference region output value acquired when the maximum light-emitting control value is outputted from the light-emitting control section 100, the reference region output value acquired when the reference region is irradiated with no irradiating light by the light-emitting section 102, and the light-emitting control value which shows that no irradiating light is emitted. In the example shown in FIG. 4A, the output value acquiring section 110 computes the linear function including the reference region output value “65535” stored in the ideal output value storage section 120, the light-emitting control value “100”, the reference region output value “0,” and the light-emitting control value “0.” The solid line shown in FIG. 4B shows the ideal output values concerning the duties of the LED of the light-emitting section 102 by a straight line drawn by the linear function.

The output value acquiring section 110 stores a set of the light-emitting control value and the ideal output value which satisfy the computed linear function in the ideal output value storing section 120 (S160). In the example shown in FIG. 4A, in addition to the light-emitting control values “0” and “100,” the output value acquiring section 110 further stores light-emitting control values “90” and “81” matched with ideal output values “58982”, and “53083”, respectively in the ideal output value storage section 120. The output value acquiring section 110 notifies the difference output value output section 130 that it is necessary to store the set of the light-emitting control value and ideal output value which satisfy the computed linear function in the ideal output value storing section 120.

By comparing the reference region output value and the ideal output value matched with the same single light-emitting control value and stored in ideal value storage section 120, the difference output value output section 130 which has received the notice acquires the difference output value by subtracting the reference region output value from the ideal output value and stores the difference output value in the ideal output value storage section 120 by matching the difference output value with the reference region output value (S170). In the example shown in FIG. 4A, the difference output value output section 130 stores difference output values “0” and “643”, etc. matched with the reference region output values “0” and “90” in the ideal output value storing section 120. In addition, a dotted line of FIG. 4B shows the reference region output values over the duty of the LED of the light-emitting section 102, and a dashed line shows the difference output values over the same duty. Moreover, FIG. 4C shows a graph which makes the reference region output values and ideal output values which are matched with the duty of the same LED the actual measurement values and the correction values, respectively. As shown in FIG. 4C, values between the points acquired from steps S100 to S150 are corrected by a known correction method, for example, by a linear correction method. The difference output value output section 130 notifies the light-emitting control section 100 that it is necessary to store the difference output values in the ideal output value storage section 120 by matching them with the reference region output values.

The light-emitting control section 100 outputs the light-emitting control value which causes the light-emitting section 102 to illuminate with a predetermined duty for reading the manuscript, for example 100% of duty, to the light-emitting section 102 and notifies the output value acquiring section 110 that it is necessary to acquire the actual measurement value of the reflected light of the manuscript when the LED illuminates. The output value acquiring section 110 acquires the actual measurement value outputted from a plurality of light-receiving elements of the light-receiving section 104 by a single imaging operation (S180). For example, in the example shown in FIG. 5A, the output value acquiring section 110 acquires the actual measurement values “51914,” “58339,” etc. The output value acquiring section 110 notifies the output value correction section 150 that the actual measurement values from the plurality of light-receiving elements of the main scanning direction, which are outputted by a single imaging operation, are acquired.

The output value correction section 150 outputs correction values obtained by correcting the actual measurement values outputted from the plurality of light-receiving elements in Step S180 on the basis of the difference output values stored in the ideal output storage section 120 (S190). For example, as shown in FIG. 4C, in the examples shown in FIGS. 4A and 5B, the output value correction section 150 computes and produces a correction value “53083” by adding a difference output value “1169” matched with same reference output value as the corresponding actual measurement value and stored in the ideal output value storage section 120 to an actual measurement value “51914.”

It is judged whether the output value acquiring section 110 imaged the entire manuscript (S200). The output value acquiring section 110 judges that the entire manuscript is imaged when a plurality of subsequent output values are not acquired within a predetermined period. In Step S200, the output value acquiring section 110 repeats steps from S180 to S200 when it is judged that the entire manuscript is not completely imaged (S200: No).

On the other hand, when it is judged in Step S200 that the output value acquiring section 110 completely imaged the entire manuscript (S200: Yes), the image forming section 160 forms an image of the manuscript on the basis of the output values outputted from the light-receiving section 104, or the output values after the correction performed by the output value correction section 150. The image forming section 160 stores the formed image of the manuscript in the image storage section 170 (S210), and the operation sequence of the flow chart ends.

According to this flow chart, it is possible to properly correct a nonlinear reading error according to the mean value of shades of reading elements. Moreover, in a weaker intensity range rather than in a stronger intensity range of the irradiating light emitted from the light-emitting section 102, the ideal output value storing section 120 stores the ideal output values for every light-emitting control value having a smaller pitch. Accordingly, in a portion with lower brightness where an error is likely to occur in the output values outputted from the light-emitting elements, it is possible to read the manuscript with high precision and to correct the image of the manuscript. In addition, for example, the minimum value of duty is 0.1% and the fixed ratio is 90%. Alternatively, the minimum value of duty and the fixed ration may be different values.

In addition, although the output value acquiring section 110 computes the arithmetic average of the output values outputted from the plurality of light-receiving elements in Steps S100 and S140, the output values outputted from selected specific light-receiving elements may be used. Furthermore, when the light-receiving section 104 has a plurality of light-receiving elements in each of channels R, G, and B, the average value may be acquired for every channel or the average value of the output values of the plurality of light-receiving elements included in three channels may be acquired.

Moreover, according to this embodiment, the scanner 20 includes the light-emitting control section 100, the light-emitting section 102, the light-receiving section 104, the output value acquiring section 110, the ideal output value storage section 120, the difference output value output section 130, the output value correction section 150, the image forming section 160, and the image storage section 170, but may have other forms. As an example, the scanner 20 may include the light-emitting control section 100, the light-emitting section 102, the light-receiving section 104, the output value acquiring section 110, the ideal output value storage section 120, the difference output value output section 130, the image forming section 160, and the image storage section 170, and the personal computer 10 may have the ideal output value storage section, the output value correction section, and the image storage section. For example, the ideal output vale storage section and the image storage section of the personal computer 10 acquires information from the ideal output value storage section 120 and the image storage section 170 of the scanner 20, respectively, and the output value correction section of the personal computer 10 may correct the pixel values of the image stored in the image storage section of the personal computer 10 on the basis of the difference output value which is the pixel value stored in the ideal output value storage section 120 of the personal computer 10.

Moreover, in Step S144 of this embodiment, although the light-emitting control section 100 outputs the light-emitting control values which decrease the duty of the LED to 90% of the last duty, a method of decreasing the duty is not limited to this. As other methods, the light-emitting control section 100 may decrease the duty of the LED from an initial value of 100% by 10% of a fixed ratio to 90%, 80%, and 70%. Furthermore, the light-emitting control section 100 may output a plurality of light-emitting control values having a smaller pitch in the range in which the intensity of the irradiating light emitted from the light-emitting section 102 is weaker than predetermined intensity. For example, when controlling the intensity of the irradiating light of the light-emitting section 102 by the duty, the light-emitting control section 100 may decrease a pitch of the light-emitting control values, which is set up in a large duty range, to a half the pitch set up in the large duty range. As an example, the light-emitting control section 100 may set the duty such that the light-emitting section 102 emits the irradiating light with the duties 100%, 90%, 80%, etc at 10% of pitch in the range from 100% to 30% of the duty and with the duties 30%, 25%, 20%, etc. at 5% of pitch which is the half of 10% in the range from 30% to 0%.

Moreover, in this embodiment, although the light-emitting control section 100 changes the intensity of the irradiating light emitted from the light-emitting section 102 by outputting the light-emitting control values which are set to change the duty, a means to change the intensity of irradiating light is not limited thereto. As another example, the light-emitting control section 100 may change the intensity of the irradiating light emitted from the light-emitting section 102 by outputting the light-emitting control values which are set to change driving current.

Moreover, in this embodiment shown in FIG. 3, operations from Step S100 to Step S170 may be performed at the time of factory shipping, and the difference output value may be written in EEPROM (not shown) of the scanner 20. Instead of this or in addition to this, the operations from Step S100 to Step S170 may be performed according to directions of a user or in advance of reading of the manuscript each time.

As mentioned above, although this invention is explained using the term of embodiment, the technical range of this invention is not limited to the range given in the term of the above-mentioned embodiment. It will be apparent to those skilled in the art that various modifications and variations may be made in the embodiment. It is apparent that all such changes, modifications, and alterations are intended to be within the scope of the present invention and the appended claims.

The entire disclosure of Japanese Patent Application No. 2007-023560, filed Feb. 1, 2007 is expressly incorporated by reference herein.

What is claimed is:

1. An image producing apparatus comprising:
a light-emitting element which irradiates a manuscript with irradiating light;
a light-receiving section which receives reflected light or transmitted light of the irradiating light irradiated on the manuscript;
a control section which causes the light-emitting element to emit the irradiating light by outputting a light-emitting control value corresponding to intensity of the irradiating light to the light-emitting element;
a recording section which records an ideal output value which should be outputted from the light-receiving section which has received the reflected light or the transmitted light from a reference region for every light-emitting control value when the reference region used for measuring a reference output value of an output value of the light-receiving section is irradiated with the irradiating light having a plurality of different intensities by the light-emitting element in response to a plurality of different light-emitting control values;
an output value acquiring section which acquires a reference output value outputted from the light-receiving section which has received the reflected light or the transmitted light from the reference region for every light-emitting control value when the reference region is irradiated with the irradiating light having the plurality of different intensities by the light-emitting element in response to the plurality of different light-emitting control values; and
an output section which outputs a difference output value between the reference output value and the ideal output value for every reference output value by comparing the reference output value matched with the same light-emitting control value and acquired by the output value acquiring section and the ideal output value recorded in the recording section,
wherein the control section outputs the light-emitting control values having a smaller pitch as the intensity of the irradiating light emitted from the light-emitting element becomes weaker, and the recording section records the ideal output value for every light-emitting control value.

2. The image producing apparatus according to claim 1, wherein the control section causes the light-emitting element to irradiate the reference region with the irradiating light having the plurality of different intensities by outputting the plurality of different light-emitting control values to the light-emitting element before image production when it receives a request for producing an image of the manuscript.

3. The image producing apparatus according to claim 1, wherein the control section sequentially outputs the plurality of different light-emitting control values in the sequence from the light-emitting control value corresponding to the highest intensity of the irradiating light emitted from the light-emitting element to the light-emitting control values which decrease the intensity of the irradiating light emitted from the light-emitting element in a fixed ratio, and the recording section records the ideal output value for every light-emitting control value outputted by the control section.

4. The image producing apparatus according to claim 1, wherein the control section outputs the light-emitting control values having a smaller pitch therebetween in a range in which the intensity of the irradiating light emitted from the light-emitting section is relatively weak rather than a range in which the intensity of the irradiating light emitted from the light-emitting section is relatively strong, and the recording section records the ideal output value for every light-emitting control value having a smaller pitch therebetween in a range in which the intensity of the irradiating light emitted from the light-emitting section is relatively weak rather than a range in which the intensity of the irradiating light emitted from the light-emitting section is relatively strong.

5. The image producing apparatus according to claim 1, wherein the light-emitting element is an LED which illuminates with a plurality of different duty cycles and the control section causes the LED to emit the irradiating light having the plurality of different intensities by outputting the light-emitting control values which cause the LED to illuminate with the plurality of different duties.

6. The image producing apparatus according to claim 1, wherein the output value acquiring section computes a linear function using the light-emitting control value and the output value as variables, in which the light-emitting control value and the output value includes the reference output value acquired when a maximum light-emitting control value is outputted from the control section, the maximum light-emitting control value, the reference output value acquired when the reference region is not irradiated with the irradiating light by the light-emitting element, and the light-emitting control value showing that the reference region is not irradiated with the irradiating light, and the recording section records a set of the light-emitting control value and the ideal output value which satisfy the linear function when the linear function is computed by the output value acquiring section.

7. The image producing apparatus according to claim 1, wherein the control section generates different light-emitting control values depending on a plurality of different image producing modes for producing an image of the manuscript, the recording section records the different ideal output values for every light-emitting control value according to the plurality of different image producing modes for producing the image of the manuscript, and the output value acquiring section acquires the different reference output values for every light-emitting control value according to the plurality of different image producing modes for producing the image of the manuscript.

8. The image producing apparatus according to claim 1, further comprising an output value correction section which outputs a correction value which is acquired by correcting an actual measurement value which is an output value of the light-receiving section which has received the reflected light or the transmitted light of the manuscript on the basis of the difference output value outputted from the difference output value output section.

9. An image producing method comprising:
irradiating a manuscript with irradiating light;
causing a light-receiving element to receive reflected light or transmitted light from the manuscript which is irradiated;
controlling the irradiating light on the basis of a light-emitting control value corresponding to intensity of the irradiating light;
irradiating a reference region used for measuring a reference output value of an output value of the light-receiving element with the irradiating light having a plurality of different intensities based on a plurality of different light-emitting control values;
recording an ideal output value which should be outputted from the light-receiving element which has received the reflected light or the transmitted light from the reference region for every light-emitting control value;
acquiring a reference output value outputted from the light-receiving element which has received the reflected light or the transmitted light from the reference region for every light-emitting control value; and
outputting a difference output value which is a difference between the reference output value and the ideal output vale for every reference output value by comparing the reference output value matched with the same light-emitting control value and the ideal output value which is recorded,
wherein the controlling is performed in a manner such that as the intensity of the irradiating light is weaker, the plurality of different light-emitting control values having a smaller pitch therebetween is outputted, and the recording is performed in a manner such that the ideal output values are recorded for every light-emitting control value.
